(19) United States
(12) Patent Application Publication
(10) Pub. No.: US 2024/0411500 A1
(43) Pub. Date: Dec. 12, 2024

(54) Color Processing Controls

(71) Applicant: Hewlett-Packard Development Company, L.P., Spring, TX (US)

(72) Inventors: Yi-Fan Lin, Taipei City (TW); Kai-Chieh Chang, Taipei City (TW); Li-Pang Liang, Taipei City (TW)

(73) Assignee: Hewlett-Packard Development Company, L.P., Spring, TX (US)

(21) Appl. No.: 18/700,230

(22) PCT Filed: Oct. 21, 2021
(86) PCT No.: PCT/US2021/056044

§ 371 Date: Apr. 10, 2024

(51) Int. Cl. G06F 3/14; G09G 5/02

(52) U.S. Cl. CPC G06F 3/1446; G09G 5/02; G09G 2300/026; G09G 2320/0242

(57) ABSTRACT

In some examples, a method includes dividing, by a first display device, video data into multiple buffers corresponding to regions of the video data. In some examples, the method includes receiving, by the first display device, an indicator from a second display device. In some examples, the method includes controlling, by the first display device, color processing of data of a first buffer of the multiple buffers based on the indicator to coordinate with the second display device.

### BACKGROUND

Some electronic devices include electronic circuitry for performing processing. As processing capabilities have expanded, electronic devices have been utilized to perform more functions. For example, a variety of electronic devices are used for work, communication, and entertainment. Electronic devices may be linked to other devices and may communicate with other devices.

### BRIEF DESCRIPTION OF THE DRAWINGS

FIG. 1 is a flow diagram illustrating an example of a method for color processing control;

FIG. 2 is a block diagram of an example of a display device that may be used to perform color processing controls;

FIG. 3 is a block diagram of an example of a source device and display devices that may be used in accordance with examples of some of the techniques described herein; and

FIG. 4 is a block diagram illustrating an example of a computer-readable medium for color processing control.

### DETAILED DESCRIPTION

A display device is an electronic device to display and/or process images (e.g., video). Color uniformity may be a challenge in the design, manufacture, and/or operation of display devices. For example, some display devices may include a liquid crystal display (LCD) cell layer and a light emitting diode (LED) backlight layer. An image may be produced by emitting light from the LED backlight layer through colors exhibited by the LCD cell layer. Nonuniformities in manufacturing may produce a nonuniform cell gap (e.g., distances) between the LCD cell layer and the LED backlight layer. Accordingly, some LCD cells may be closer to a light source than other LCD cells, which may lead to color variation over portions of the display panel. For instance, some portions of the display panel may exhibit a reddish tint or a bluish tint due to the nonuniform cell gap.

In some cases, color nonuniformity exhibited by a display device may be caused by color filtering nonuniformity. In some examples, display devices may include color filters (on a layer above LCD cells, for instance) to control color by filtering light wavelengths emitted from the LCD cells. During manufacture (e.g., assembly procedures), the color filters may be shifted or misaligned (e.g., nonuniformly shifted or misaligned) to a degree relative to the LCD cells. The misalignment may cause the panel to exhibit color nonuniformity (e.g., reddish tint, bluish tint, etc.) in a portion or portions of the panel.

In some cases, color nonuniformity exhibited by a display device may be caused by an LED color variation. For instance, LED manufacturing variations may cause different LEDs to exhibit different colors when a similar voltage is applied. The variations may cause the panel to exhibit color nonuniformity (e.g., reddish tint, bluish tint, etc.) across a panel in a portion or portions of the panel. In some examples, a panel may exhibit a uniform reddish or bluish tint after calibration. However, when the panel is viewed, an angle of light may produce variation in blue and/or red tint across the panel even when uniformly calibrated in some examples.

Color nonuniformity may become more apparent when display devices are arranged nearby. For instance, a user may arrange two display devices side-by-side, with a first display device is situated on a left side and a second display device is situated on a right side. If neighboring portions of the panels exhibits different tints, a color difference may be apparent. For instance, if a rightmost portion of a panel of the first display device on the left exhibits a bluish tint and a leftmost portion of a panel of the second display device on the right exhibits a reddish tint, a color difference may be apparent.

Some examples of the techniques described herein may provide color processing controls. Color processing is processing to adjust and/or modify color of an image. In some examples, color processing may be performed to adjust a color gain, color encoding, brightness, and/or color temperature, etc., of an image(s) (e.g., video). For instance, color processing controls may be provided to reduce color differences at boundaries between display devices. In some examples, video data may be split into different buffers corresponding to different regions of video data. Color processing of a region or regions may be controlled to coordinate display devices. For instance, coordinating between display devices may include matching, approximately matching, and/or reducing a difference in color processing, appearance, color gain, etc., between display devices at a neighboring boundary (ies) and/or edge(s) between display devices.

An electronic device is a device that includes electronic circuitry (e.g., integrated circuitry, a chip(s), etc.). Examples of electronic devices may include docks, monitors, televisions, display devices, display panels, graphics cards, graphics processing units (GPUs), motherboards, computing devices, smartphones, tablet devices, game consoles, etc. Some examples of electronic devices may utilize circuitry (e.g., controller(s) and/or processor(s), etc.) to perform an operation or operations. In some examples, electronic devices may execute instructions stored in memory to perform the operation(s). Instructions may be code and/or programming that specifies functionality or operation of the circuitry. In some examples, instructions may be stored in memory (e.g., Random-Access Memory (RAM), Read-Only Memory (ROM), Erasable Programmable Read-Only Memory (EPROM), Electrically Erasable Programmable Read-Only Memory (EEPROM), flash memory, dynamic random-access memory (DRAM), synchronous DRAM (SDRAM), magnetoresistive random-access memory (MRAM), phase-change random-access memory (PCRAM), hard disk drive (HDD), solid state drive (SSD), optical drive, etc.). In some examples, different circuitries in an electronic device may store and/or utilize separate instructions for operation.

In some examples, an electronic device may be linked to another electronic device or devices using a wired link. For example, an electronic device (e.g., display device, monitor, television, etc.) may include a wired communication interface (e.g., connector or connectors) for connecting electronic devices. Connectors are structures that enable forming a physical and/or electrical connection. For instance, a connector may be a port, plug, and/or electrical interface, etc. A connector or connectors may allow electronic devices to be connected with a cable or cables. Examples of connectors include DisplayPort™ (DP) connectors, High-Definition Multimedia Interface (HDMI®) connectors, Universal Serial Bus (USB) connectors, Lightning® connectors, Digital Visual Interface (DVI) connectors, optical-copper link (OCuLink) connectors, Ethernet connectors, etc.

In some examples, an electronic device may be linked to another electronic device with a wireless link. For instance, an electronic device (e.g., display device, monitor, television, etc.) may include a wireless communication interface to send and/or receive wireless (e.g., radio frequency (RF)) signals. Examples of wireless communication interfaces may include an Institute of Electrical and Electronics Engineers (IEEE®) 802.11 (WI-FI®) interfaces, Bluetooth® interfaces, cellular (e.g., 3G, Long-Term Evolution (LTE®), 4G, 5G, etc.) interfaces, etc.

A link between electronic devices may be a direct link (e.g., without an intervening device) or an indirect link (e.g., with an intervening device or devices). For instance, a link may be established between electronic devices over a network using a dock(s), hub(s), repeater(s), splitter(s), router(s), and/or switch(es), etc.

In some examples, an electronic device may be linked to another electronic device to communicate a video signal. For instance, when the electronic devices are linked (e.g., a cable is plugged into both electronic devices and/or wireless communication is set up between electronic devices), the electronic devices may follow a protocol or protocols to set up a video link. A video link is a communication channel for video. For instance, a video link may carry a video stream (e.g., data corresponding to a series of video frames with or without audio) from one electronic device to another. A video link may include a physical and/or logical aspect or aspects. For instance, a video link may be set up when a cable is physically connected and/or a protocol condition or conditions are satisfied to enable video stream communication. In some examples, setting up a video link may be referred to as enumerating a display. As used herein, a “source device” is an electronic device for sending video and a “sink device” is an electronic device for receiving video. In some examples, an electronic device may be a source device or a sink device. In some examples, an electronic device (e.g., hub, daisy-chained monitor, etc.) may be source device and a sink device.

In some examples, setting up a video link (e.g., enumerating a display) may follow a protocol. For instance, a protocol may include a sequence of messages and/or functions to set up the video link. In some examples, DP video link setup may include hot plug detection (HPD), display identification (DisplayID) and/or extended display identification data (EDID) read, DisplayPort configuration data (DPCD) read, link training, and/or video stream output. In some examples, HDMI video link setup may include HPD, DisplayID and/or EDID read, and/or video stream output. Video link setup may vary based on the protocol(s) utilized and/or type of connection. For instance, video link setup for some protocols may utilize a connection detection signal and display data (e.g., DisplayID and/or EDID) without other setup data (e.g., DPCD) and/or without link training. In some examples, video link setup for another protocol may utilize a connection detection signal, display data (e.g., DisplayID and/or EDID), setup data (e.g., DPCD) and/or link training. Some of the data described herein (e.g., video data, color map(s), etc.) may be requested, sent, and/or received. For instance, an electronic device may request, send, and/or receive some of the signaling and/or data (e.g., detection signal, DisplayID, EDID, DPCD, color map(s), etc.) described herein during detection, setup, and/or enumeration procedures.

HPD is a procedure where a signal (e.g., voltage, current, signal pattern, etc.) is sent or provided from one electronic device to another electronic device to indicate that a physical connection is made. For instance, a display may send or provide a signal to a GPU indicating that a physical connection is made between the display and the GPU.

In some examples, display data read may be a procedure where DisplayID and/or EDID is sent from one electronic device to another electronic device. Display data is data indicating a characteristic or characteristics of a display. For instance, DisplayID and/or EDID may include data indicating a manufacturer identifier (e.g., name), serial number, display size, supported timing(s), resolution(s) device type, and/or another characteristic or characteristics, etc. In some examples, a sink device may send the DisplayID and/or EDID to a source device to indicate a capability or capabilities of (e.g., video stream format(s) that can be displayed by) the sink device. In some examples, DisplayID and/or EDID may include examples of the metadata described herein.

In some examples, DPCD read may be a procedure where DPCD is sent from one electronic device to another electronic device. DPCD is data for a DP link. For instance, DPCD may include data indicating supported lane(s), supported bitrate(s), whether multi-touch is supported, repeater capability, and/or another characteristic or characteristics, etc. In some examples, a sink device may send the DPCD to a source device to indicate a capability or capabilities of the sink device for a DP link.

In some examples, link training may be a procedure where information is exchanged between electronic devices to assess and/or adjust a link parameter or parameters. For instance, link training may include signaling video from a source device to a sink device, assessing link quality, sending link quality indicator(s) from the sink device to the source device, and/or sending a voltage adjustment request from the sink device to the source device and/or other assessment(s) and/or adjustment(s), etc. In some examples, a source device may adjust a link parameter or parameters (e.g., output signal voltage) in link training.

In some examples, video stream output may be a procedure where video data is output from a source device to a sink device. For instance, a source device may send a series of video frames and/or audio to a sink device.

In some examples of the techniques described herein, an indicator(s) is a signal, datum, data, or a combination thereof (e.g., color map(s), color table(s), red, green, and blue (RGB) gain(s), etc.) may be communicated during link setup (e.g., enumeration) and/or after link setup. For instance, a structure or structures (e.g., data pattern, signaling pattern, message structure, packet structure, etc.) may be established to indicate the signal(s) and/or data described herein in enumeration procedures and/or after enumeration procedures.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

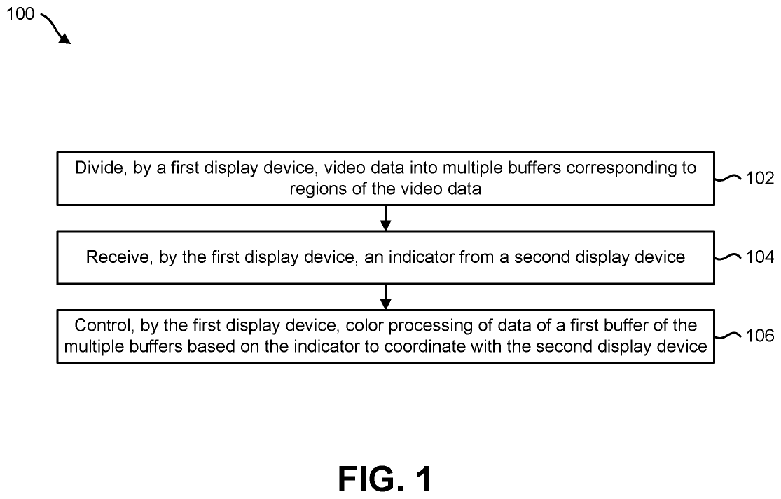

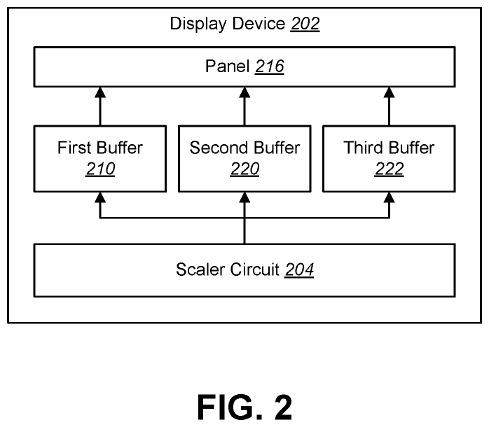

FIG. 1 is a flow diagram illustrating an example of a method 100 for color processing control. The method 100 and/or a method 100 element(s) may be performed by an electronic device (e.g., sink device and/or display device, etc.). In some examples, the method 100 may be performed by a first display device (e.g., sink device). For instance, the method 100 may be performed by the display device 202 described in relation to FIG. 2. Examples of a display device may include a monitor, television, display, GPU (e.g., GPU of a notebook computer), computing device to process image data, and/or other circuitry to process image data (e.g., video). The first display device may be connected to a device or devices. For instance, the first display device may be connected to a source device (e.g., computer, GPU, another display device, etc.). In some examples, the first display device may be connected to a second display device in a daisy-chain arrangement. For instance, a source device may be connected to the first display device, which may be connected to the second display device. Or, a source device may be connected to the second display device, which may be connected to the first display device. In some examples, the method 100 and/or parts thereof may be performed during and/or after video link enumeration.

The method 100 includes dividing 102, by a first display device, video data into multiple buffers corresponding to regions of the video data. For example, a first display device may receive video data from a source device. The video data may represent an image or frame (e.g., frame of video). The video data may be received via a wired or wireless interface (e.g., HDMI®, USB, Lightning®, DP, WI-FI®, and/or Bluetooth®, etc.). In some examples, a remote device (e.g., remote computing device, remote server, cloud server, etc.) may divide the video data and may send the divided video data (e.g., a region or region(s) of the video data) to the first display device.

The first display device divides 102 the video data into multiple buffers corresponding to regions of the video data. A buffer is circuitry (e.g., memory) that stores video data. For instance, a buffer may store video data representing pixels of an image or frame. Each of the multiple buffers may be separate circuitry (e.g., separate memory circuits) or may be portions of a circuit (e.g., address ranges of a memory circuit). In some examples, the multiple buffers may be hardware buffers. In some examples, the multiple buffers may be virtual buffers (e.g., portions of memory, distinct address ranges of a memory circuit) and/or logical buffers (e.g., subsets and/or divisions of one hardware buffer and/or memory circuit). In some examples, dividing the video data into multiple buffers comprises splitting the video data (e.g., an image, a frame) into different subsets and loading (e.g., storing) the subsets into different buffers. In some examples, the subsets and/or regions are vertical portions of an image or frame. For example, an image or frame with dimensions 1920 pixels (px)×1080 lines may be divided into three subsets with dimensions 640 px×1080 lines, where px corresponds to a width and 1080 corresponds to a height of an image or frame. In some examples, the subsets and/or regions may be overlapping or non-overlapping. In some examples, the regions correspond to spatial subsets of a display panel. For instance, each of the image regions may be displayed on a respective spatial subset of a display panel.

In some examples, the first display device includes a scaler circuit to divide the video data into the multiple buffers. A scaler circuit is a circuit (e.g., integrated circuit, microcontroller unit, processor, etc.) to provide image processing and/or control functionality. For instance, the scaler circuit may control (e.g., select) a video input, decode video data, divide (e.g., split) video data, perform image processing (e.g., color processing, contrast adjustment, gamma adjustment, and/or upscaling, etc.), perform backlight control, and/or insert an on-screen display (OSD), etc.

In some examples, the scaler circuit may be included in a scaler board. For instance, the first display device may include a scaler board. The scaler board may include the scaler circuit and/or other circuitry (e.g., interface circuitry, memory, a frame controller, etc.). In some examples, the scaler board may include the multiple data buffers. For instance, the scaler board may include multiple memory circuits as the multiple buffers or may include one memory circuit with multiple partitions allocated to the multiple buffers.

The method 100 includes receiving 104, by the first display device, an indicator from a second display device. The first display device may receive 104 the indicator from the second display device via an interface. The indicator is information relating to color processing. In some examples, the indicator may be a signal, message, packet, digital signal, etc. For instance, the indicator may include a color map(s) (e.g., RGB gains) from the second display device and/or may include an instruction(s) to adjust color processing on the first display device.

In some examples, the indicator is a color map of the second display device. A color map is information indicating an aspect of color processing spatially mapped to an image, frame, and/or region(s) (of a display panel, for instance). For instance, separate color maps may correspond to different regions of a display panel (independent of an image displayed, for example). For instance, an image of a window may vary in appearance (e.g., red or blue tint) based on which region the image is displayed in. In some examples, the color map may correspond to a whole panel, image, or frame. In some examples, the color map may correspond to a region of a panel, image, or frame (e.g., a region of a panel of the second display device that neighbors a region of panel of the first display device). For instance, the color map may correspond to a rightmost region of a panel when the second display device is situated to the left of the first display device. In some examples, a color map may indicate one value for a region, or varying values for a region. In some examples, the first display device may receive 104 multiple color maps from the second display device. For instance, the first display device may receive color maps corresponding to multiple (e.g., some or all) regions of another panel for the second display device.

The method 100 includes controlling 106, by the first display device, color processing of data of a first buffer of the multiple buffers based on the indicator to coordinate with the second display device. For instance, the first display device (e.g., scaler circuit) may change color processing of a first buffer such that the color of a first region corresponding to the first buffer is similar to a color of the second display device (e.g., color of a second region on the second display device that neighbors the first region of the first display device). In some examples, the first display device (e.g., scaler circuit) may change color processing by adjusting color processing corresponding to the first buffer to reduce a difference in color between the first region corresponding to the first buffer and a neighboring region on the second display device that neighbors the first region of the first display device.

In some examples, controlling 106 color processing may include controlling a RGB gain of the first buffer independently from a second buffer of the multiple buffers. RGB gain is a value or values indicating color and/or brightness. In some examples, a darkest red color R=R0 and a brightest red color R=R255, a darkest green color G=GO and a brightest green color G=G255, and/or a darkest blue color B=B0 and a brightest blue color B=B255. In some examples, RGB gain may indicate a brightness or luminance value. For instance, L0 may indicate a lowest (e.g., darkest) RGB gain and L255 may indicate a highest (e.g., brightest) RGB gain. RGB gain may affect a color temperature of a white color on a display panel. In some examples, RGB gain may be indicated by a color map.

In some examples, controlling 106 the color processing of the data of the first buffer may include swapping a first color map of the first buffer with a second color map of a second buffer. For instance, each buffer and/or region may have a corresponding color map. The color map may indicate an aspect or aspects of color processing for the buffer and/or region. In some examples, the first display device (e.g., scaler circuit) may swap (e.g., trade, exchange, etc.) the first color map of the first buffer with the second color map of the second buffer by applying the second color map to the first buffer and by applying the first color map to the second buffer.

In some examples where the indicator is a color map from a second display device, the first display device may control 106 color processing by determining a color map of the first display device that is nearest to the color map of the second display device. For instance, the first display device (e.g., scaler circuit) may compare the color map from the second display device to each of the color maps corresponding to the multiple buffers. For instance, the first display device (e.g., scaler circuit) may determine differences in RGB gain between the color map of the second display device and a color map of each buffer. The color map with the smallest difference may be applied to the first buffer (e.g., first region that neighbors the second display device). The color map of the first buffer may be applied to the buffer of the determined color map.

In some examples, controlling 106 the color processing of the data of the first buffer may include adjusting a first color map of the first buffer. In some examples, the indicator received 104 from the second display device may indicate a change in color processing of a first buffer of the multiple buffers. For instance, the second display device may send an indicator that instructs the first display device to change a RGB gain value of the first buffer to approximately match the RGB gain value of a region of the second display device that neighbors the first region corresponding to the first buffer. The first display device (e.g., scaler circuit) may adjust the RGB gain according to the received indicator. For instance, the first display device may coordinate with the second display device by reducing a color difference at an edge of a display panel of the first display device that borders (e.g., neighbors, is nearest to, etc.) the second display device.

In some examples, the first display device may send a color map(s) to the second display device. For instance, the first display device (e.g., scaler circuit) may send a color map or maps corresponding to a buffer or buffers (e.g., region or regions) of the first display device. For instance, the color map may correspond to a whole image or frame. In some examples, the color map may correspond to a region of an image or frame (e.g., a region of an image for the first display device that neighbors a region of an image for the second display device). For instance, the color map may correspond to a leftmost region of an image when the first display device is situated to the right of the second display device. In some examples, the first display device may send multiple color maps to the second display device. For instance, the first display device may send color maps corresponding to multiple (e.g., some or all) regions of the first display device. In some examples, the indicator from the second display device is received in response to sending the color map(s). For instance, the second display device may determine a swap and/or adjustment for the first display device and may send the indicator to indicate the swap and/or adjustment. In some examples, the indicator indicates a change in the color processing of the data of the first buffer. For instance, the indicator may indicate a change in the color processor of the first buffer to approximately match (and/or reduce a color difference between) neighboring regions between the first display device and the second display device.

In some examples, the method may include applying an RGB gain curve over the multiple buffers corresponding to the regions. An RGB gain curve is a function or set of values that indicate an RGB gain over a dimension(s) of an image (e.g., over lines, columns, a horizontal dimension, an x dimension, etc.). For instance, an RGB gain curve may map varying RGB gains over a dimension or dimension of an image (e.g., video frame). In some examples, the first display device (e.g., scaler circuit) may apply varying RGB gains indicated by the RGB gain curve over the buffers corresponding to the regions. In some examples, the RGB gain curve may be expressed as a linear, piecewise linear, logarithmic, exponential, gaussian, and/or other function. In an example with three buffers and/or regions across a horizontal dimension, the first display device (e.g., scaler circuit) may apply a down-smoothing curve with a gaussian shape that starts at L0 on the left edge of the left buffer, peaks at L255 in the center of the center buffer, and returns to L0 at the right edge of the right buffer. In another example with three buffers and/or regions across a horizontal dimension, the first display device (e.g., scaler circuit) may apply an up-smoothing curve with an inverse gaussian shape that starts at L255 on the left edge of the left buffer, reaches a bottom at L0 in the center of the center buffer, and returns to L255 at the right edge of the right buffer. In some examples, another function(s) may be utilized. For instance, a shallow or compressed gaussian shape may be utilized (e.g., starting at L100, peaking at L255, and returning to L100 across the image).

FIG. 2 is a block diagram of an example of a display device 202 that may be used to perform color processing controls. Examples of the display device 202 may include a monitor, smart display, television, tablet device, smartphone, touchscreen, computer screen, projector, etc. The display device 202 may be an example of the electronic device(s) and/or display device(s) described in relation to FIG. 1. In some examples, the display device 202 may perform a method or methods (e.g., method 100) and/or an operation or operations described herein. The display device 202 may be connected to and/or linked to a source device(s) and/or other display device(s) (not shown in FIG. 2) in some examples.

A source device is a device that generates, produces, provides, and/or outputs video data (e.g., image(s), a video stream, video frames, etc.). Examples of a source device may include a computing device, a display device, GPU, audio/video (A/V) receiver, smartphone, laptop computer, media player, game console, television stick, media receiver, media drive, media server, disc player (e.g., digital versatile disc (DVD) player, Blu-ray Disc™ player, etc.), video doorbell, display device, hub, dock, etc.

A source device may be linked to the display device 202 with a link. The link may be a wired or wireless link. In some examples, a wired link (e.g., cable) may include multiple wires and/or pins. The link may provide a channel or channels (e.g., data channel, auxiliary channel, and/or connection detection channel, etc.) for communication. A channel may be a physical channel (e.g., wire) and/or a logical channel (e.g., frequency domain and/or time domain resources, multiplexed channel, etc.). More or fewer channels, links, and/or cables may be used in some examples.

In some examples, a source device may include transmission circuitry and/or reception circuitry. The link may be provided by and/or connected to the transmission circuitry and/or reception circuitry of a source device.

In some examples, the auxiliary channel may carry information and/or messages to set up a data link (e.g., to perform enumeration) between the source device and the display device 202. For instance, the auxiliary channel may carry a request or requests (e.g., identification request(s), setup data request(s), link training request(s), and/or timing data request(s), etc.), display data (e.g., DisplayID and/or EDID), setup data (e.g., DPCD), link training data, and/or timing data, etc.

In some examples, the data link may carry video data (e.g., images, a video stream, and/or video frames) from the source device to the display device 202. Once the data link is set up, for instance, the data link may carry the video signal to the display device 202.

The display device 202 includes a panel 216. The display device 202 may be an example of a sink device. For example, the display device 202 may receive and/or display video data (e.g., a video stream, video frames, etc.).

The display device 202 may include a panel 216, a scaler circuit 204, a first buffer 210, a second buffer 220, and/or a third buffer 222. The components described in relation to FIG. 2 may be examples of corresponding components described in relation to FIG. 1. The panel 216 is circuitry to display optical information. Examples of the panel 216 may include LED LCD panels, microLED panels, and/or miniLED panels, etc. The panel 216 may display video data (e.g., video data from the source device). The scaler circuit 204 is circuitry to control the display device 202. In some examples, the scaler circuit 204 may be a microcontroller unit (MCU), application-specific integrated circuit (ASIC), and/or other circuitry. In some examples, the scaler circuit 204 may read and/or execute instructions stored in memory to perform an operation or operations (e.g., method 100 and/or operation(s) thereof) described herein. For instance, the scaler circuit 204 may include memory and/or may have access to memory on a scaler board (not shown in FIG. 2). The memory is a device (e.g., circuitry) to store information. Examples of the memory may include ROM, EPROM, EEPROM, flash memory, DRAM, SDRAM, MRAM, PCRAM, HDD, SSD, optical drive, etc.

The scaler circuit 204 may be coupled to the first buffer 210, the second buffer 220, and/or the third buffer 222 included in the display device 202. For instance, the scaler circuit 204 may be directly coupled or indirectly coupled (through a frame controller, for instance) to the first buffer 210, the second buffer 220, and the third buffer 222. Some examples of display devices may include three buffers as illustrated in FIG. 2. In some examples, a display device may include two, three, four, or more buffers for corresponding regions. The first buffer 210, the second buffer 220, and the third buffer 222 may be devices (e.g., circuitry) to store information. Examples of the first buffer 210, the second buffer 220, and the third buffer 222 may include flash memory, RAM, DRAM, SDRAM, MRAM, PCRAM, etc. In some examples, the first buffer 210, the second buffer 220, and the third buffer 222 are included in a scaler board.

In some examples, the scaler circuit 204 and/or a scaler board may include an interface (not shown in FIG. 2. The interface is circuitry to communicate with an electronic device(s) (e.g., source device, sink device, and/or another display device, etc.). The interface may be a wired and/or wireless communication interface (e.g., WI-FI® communication interface, Bluetooth® communication interface, cellular communication interface, etc.). In some examples, the interface may include a port or ports and corresponding circuitry to support a link or links. For instance, some ports may be utilized to link to a device (e.g., the source device, sink device, and/or another display device, etc.) that may be external to the display device 202. Examples of ports with supporting circuitry may include a Universal Serial Bus (USB) interface (e.g., USB Type-C® (USB-C®), USB Type-A, USB Type-B, USB 2.0, USB 2.0, USB Mini-B, USB Micro-B, etc.), Lightning® interface, Ethernet interface, DisplayPort™ interface, HDMI® interface, etc. In some examples, the interface may include a port, transceiver circuitry, and/or an interface controller. For instance, the interface may enable receiving video data for display on the display device 202. In some examples, the interface may receive video data from a source device.

The scaler circuit 204 may receive an indicator to coordinate display color with a second display device. For instance, the scaler circuit 204 may receive an indicator as described in relation to FIG. 1. In some examples, the scaler circuit 204 may receive the indicator via the interface. For instance, the indicator may be received via an auxiliary channel, a side channel, or another channel. In some examples, the scaler circuit 204 may produce an OSD. For instance, the scaler circuit 204 may insert and/or overwrite some of the video data to depict an OSD. In some examples, the scaler circuit 204 may produce the OSD in response to received input. For instance, the display device 202 may include a button(s). The scaler circuit 204 may produce the OSD and/or control the OSD in response to detected button presses. In some examples, the scaler circuit 204 may receive the indicator in response to detected button press(es) associated with the OSD. For instance, the OSD may include a menu option to change a color map(s) (e.g., to swap color maps and/or to adjust a color map(s)) to coordinate with another display device.

The scaler circuit 204 may receive video data from a source device. For instance, the scaler circuit 204 may receive video data as described in relation to FIG. 1. In some examples, the scaler circuit 204 may receive the video data via the interface. For instance, the video data may be received via a data channel. A data channel is a channel to communicate data (e.g., payload data, video data, etc.).

The scaler circuit 204 may split the video data into video data subsets. For instance, the scaler circuit 204 may divide the video data into video data subsets as described in relation to FIG. 1. The scaler circuit 204 may respectively provide the video data subsets to the first buffer 210, to the second buffer 220, and to the third buffer 222. For instance, a first video data subset may be provided to the first buffer 210, a second video data subset may be provided to the second buffer 220, and a third video data subset may be provided to the third buffer 222. As described above, the first buffer 210, the second buffer 220, and the third buffer 222 may be coupled to the scaler circuit 204. The first buffer 210, the second buffer 220, and the third buffer 222 may respectively store the video data subsets.

The scaler circuit 204 may control color processing of the first video data subset based on the indicator. For instance, the scaler circuit 204 may control color processing of the first video data subset as described in relation to FIG. 1. For instance, the scaler circuit 204 may swap color maps between buffers (e.g., between the first buffer 210 and the third buffer 222). For example, the scaler circuit may swap color maps between the first video data subset and the third video data subset in response to the indicator. In some examples, the scaler circuit 204 may adjust a color map of the first buffer 210, the second buffer 220, and/or the third buffer.

The panel 216 may display the video data subsets. For instance, the first buffer 210, the second buffer 220, and the third buffer 222 may provide the first video data subset, the second video data subset, and the third video data subset to the panel 216. The panel 216 may drive panel cells (e.g., LCD cells and/or LED cells) to display an image indicated by a combination of the first video data subset, the second video data subset, and the third video data subset.

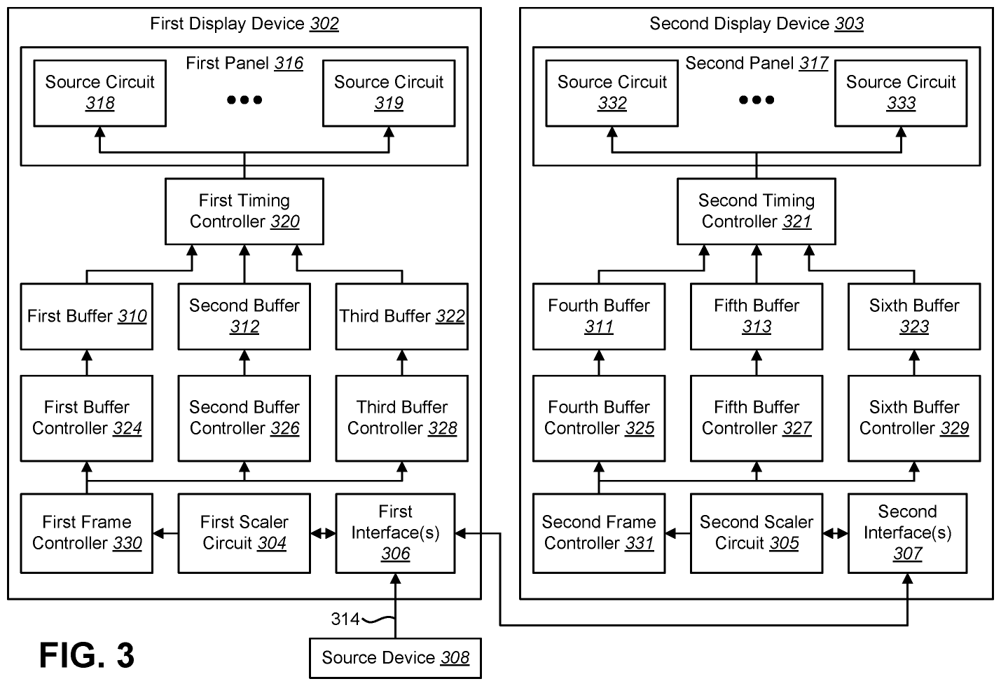

FIG. 3 is a block diagram of an example of a source device 308 and display devices 302, 303 that may be used in accordance with examples of some of the techniques described herein. The first display device 302 and/or the second display device 303 may be an example(s) of the electronic device(s) and/or display device(s) described in relation to FIG. 1 and/or FIG. 2. In some examples, first display device 302 and/or the second display device 303 may perform a method or methods (e.g., method 100) and/or an operation or operations described herein. In this example, first display device 302 is connected to the source device 308 and the second display device 303 is connected to first display device 302 in a daisy-chain arrangement. In some examples of a daisy-chain arrangement, first display device 302 may be a source device for the second display device 303.

The source device 308 may outputs video data (e.g., image(s), a video stream, video frames, etc.). The source device 308 may be an example of the source device(s) described in relation to FIG. 1 and/or FIG. 2.

A source device 308 may be linked to the first display device 302 with a link 314. The link 314 may be an example of the link(s) described in relation to FIG. 1 and/or FIG. 2. In some examples, the link may carry video data (e.g., images, a video stream, and/or video frames) from the source device 308 to the first display device 302.

The first display device 302 may include a first panel 316, first timing controller 320, first buffer 310, second buffer 312, third buffer 322, first buffer controller 324, second buffer controller 326, third buffer controller 328, first frame controller 330, first scaler circuit 304, and/or first interface(s) 306. In some examples, the first scaler circuit 304 may read and/or execute instructions stored in memory to perform an operation or operations (e.g., method 100 and/or operation(s) thereof) described herein. For instance, the first scaler circuit 304 may include memory and/or may have access to memory on a scaler board (not shown in FIG. 2) of the first display device 302. The second display device 303 may include a second panel 317, second timing controller 321, fourth buffer 311, fifth buffer 313, sixth buffer 323, fourth buffer controller 325, fifth buffer controller 327, sixth buffer controller 329, second frame controller 331, second scaler circuit 305, and/or second interface(s) 307. In some examples, the second scaler circuit 305 may read and/or execute instructions stored in memory to perform an operation or operations (e.g., method 100 and/or operation(s) thereof) described herein. For instance, the second scaler circuit 305 may include memory and/or may have access to memory on a scaler board (not shown in FIG. 2) of the second display device 303. The components of the display devices 302, 303 may be examples of corresponding components described in relation to FIG. 1 and/or FIG. 2. In some examples, a component or components of the first display device 302 and/or of the second display device 303 may perform an operation or operations described in relation to FIG. 1 and/or FIG. 2.

A frame controller is a circuit that controls frame data. For instance, the first frame controller 330 may be a 3-part frame controller that receives video data subsets from the first scaler circuit 304 and/or may respectively provide video data subsets to the first buffer controller 324, the second buffer controller 326, and the third buffer controller 328. In some examples, a frame controller (e.g., the first frame controller 330) may be a calculator with a line buffer. In some examples, a frame controller may include transmitter and receiver circuits. In some examples, a frame controller may receive video data (e.g., line data) from a scaler circuit (e.g., the first scaler circuit 304) and provide the video data (e.g., whole line data) to buffers (e.g., the first buffer 310, the second buffer 312, the third buffer 322) for storage. In some examples, after storing the line data, for instance, a 1920×1080 image may have 2160 lines. In some examples, a frame controller may separate the 1920×1080 image into 3*(960*1080). In some examples, a frame controller may be included in a scaler circuit and/or may be controlled by a scaler circuit to produce video data subsets. The first frame controller 330 may be coupled to the first buffer controller 324, the second buffer controller 326, and the third buffer controller 328. A buffer controller is a circuit that controls a buffer. For instance, a buffer controller may control buffer writing, output timing, etc. For instance, the first buffer controller 324 may write a first video data subset of a frame to the first buffer 310 and/or may control when the first video data subset of the frame is provided to the first timing controller 320.

A timing controller is a circuit that controls the timing and/or order in which video data is provided to a panel. For instance, the first timing controller 320 may be coupled to the first buffer 310, the second buffer 312, and the third buffer 322. The first timing controller 320 may provide video data (from the first buffer 310, the second buffer 312, and the third buffer 322) to source circuits 318-319. The source circuits 318-319 may be included in the first panel 316 and/or in a timing controller (TCON) board. For instance, the first timing controller 320 may read out lines of pixel data to source circuits 318-319 in a refresh sequence.

A source circuit is a circuit to drive panel cells. For instance, a source circuit 318 may convert pixel data to voltages to drive a set (e.g., line(s), column(s), and/or row(s), etc.) of panel cells of the first panel 316. In some examples, a component or components of the second display device 303 (e.g., the second panel 317, source circuits 332-333, the second timing controller 321, the fourth buffer 311, the fifth buffer 313, the sixth buffer 323, the fourth buffer controller 325, the fifth buffer controller 327, the sixth buffer controller 329, the second frame controller 331, the second scaler circuit 305, and/or the second interface(s) 307) may operate similarly to (and/or in coordination with) a component or components of the first display device 302. While two display devices are shown in FIG. 3, two or more display devices may be utilized (e.g., daisy-chained) in some examples of the techniques described herein.

In some examples, the source device 308 may provide video data to the first display device 302 (e.g., the first interface(s) 306). The first display device 302 (e.g., the first scaler circuit 304 and/or the first interface(s) 306) may utilize a first part of the video data to display on the first panel 316 and/or may pass a second part of the video data to the second display device 303 (e.g., part of the video data for a second monitor or screen for instance). In some examples, the first scaler circuit 304 may be a master scaler circuit to control the second scaler circuit 305 (and/or an additional scaler circuit(s) of an additional display device(s)).

In some examples, the second scaler circuit 305 may send color maps corresponding to the fourth buffer 311, the fifth buffer 313, and the sixth buffer 323 to the first scaler circuit 304 (via the second interface(s) 307 and the first interface(s) 306). For instance, the first scaler circuit 304 may send a request to the second scaler circuit 305 for the color maps to trigger sending the color maps or the second scaler circuit 305 may send the color maps to the first scaler circuit 304 without a request.

In some examples, the first scaler circuit 304 may compare the color map corresponding to the third buffer 322 to the color maps corresponding to the fourth buffer 311, the fifth buffer 313, and the sixth buffer 323. For instance, a fourth color map of the fourth buffer 311 may have an RGB gain range from L0 to L255 (from left to right of a left region), a fifth color map of the fifth buffer 313 may have an RGB gain of L255 (over a center region), and a sixth color map of the sixth buffer 323 may have an RGB gain range from L255 to L0 (from left to right of a right region). In this example, a color map corresponding to the third buffer 322 (a right region of the first display device 302) may have an RGB gain range from L0 to L255. In some examples, the first scaler circuit 304 may determine that a leftmost RGB gain of the sixth color map corresponding to the sixth buffer 323 is closest to a rightmost RGB gain of the color map of the third buffer 322. The first scaler circuit 304 may send an indicator to the second scaler circuit 305 instructing the second scaler circuit 305 to swap the fourth color map and the sixth color map. The second scaler circuit 305 may swap the fourth color map and the sixth color map, which may result in the sixth color map (with RGB range from L255 to L0) being applied to the fourth buffer 311 and/or the fourth color map (with RGB range from L0 to L255) being applied to the sixth buffer 323. The swap may reduce the discontinuity between the rightmost RGB gain of the third buffer 322 (e.g., L255) and the leftmost RGB gain of the fourth buffer 311 (e.g., L255). In some examples, the second scaler circuit 305 may adjust an RGB gain (e.g., RGB gain of the fifth buffer 313 from L255 to L0) and/or may apply a gain curve to the fourth buffer 311, the fifth buffer 313, and the sixth buffer 323 to smooth the gain variation over the regions displayed on the second panel 317.

In some examples, the first scaler circuit 304 may control the second scaler circuit 305 to perform a direct color map (e.g., RGB gain) adjustment of the fourth buffer 311. For instance, the first scaler circuit 304 may send an indicator instructing the second scaler circuit 305 to increase the RGB gain of the fourth buffer 311 to L255 to coordinate color with the rightmost gain of the third buffer 322.

In some examples, the first scaler circuit 304 may control color processing for a local buffer(s) and/or remote buffer(s) to coordinate color between display devices. For instance, upon receiving the color map(s) from the second scaler circuit 305, the first scaler circuit 304 may adjust the color map (e.g., RGB gain(s)) of the third buffer 322 to match (or to reduce a difference with) the fourth buffer 311. For instance, the first scaler circuit 304 may reduce a rightmost RGB gain of the third buffer 322 to L0 to coordinate with a leftmost RGB gain of the fourth buffer 311.

In some examples, a third display device (not shown in FIG. 3) may be utilized. For instance, the second display device 303 may be connected to the third display device in a daisy chain arrangement. In some examples, the second display device 303 may control a scaler circuit of the third display device to coordinate color between the sixth buffer 323 and a leftmost buffer of the third display device. In some examples, the first scaler circuit 304 may receive color maps from all display devices in the daisy chain arrangement (e.g., from the third display device) and may control all of the scaler circuits to coordinate colors at the boundaries between display devices.

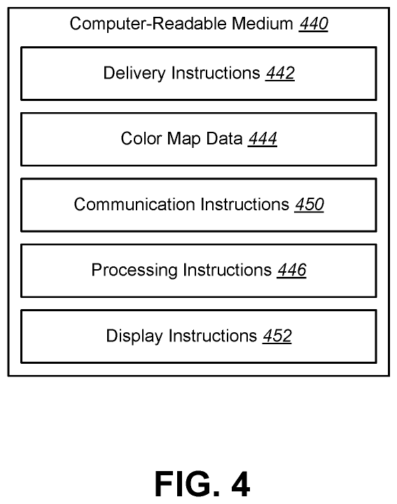

FIG. 4 is a block diagram illustrating an example of a computer-readable medium 440 for color processing control. The computer-readable medium 440 may be a non-transitory, tangible computer-readable medium. The computer-readable medium 440 may be, for example, RAM, EEPROM, a storage device, an optical disc, and/or the like. In some examples, the computer-readable medium 440 may be volatile and/or non-volatile memory, such as DRAM, EEPROM, MRAM, PCRAM, memristor, flash memory, and/or the like. In some examples, the computer-readable medium 440 may be included in a display device and/or may be accessible to a processor of a display device. In some examples, the computer-readable medium 440 may be an example of the memory (ies) described in relation to FIG. 2 and/or FIG. 3.

The computer-readable medium 440 may include data (e.g., information and/or executable instructions, etc.). For example, the computer-readable medium 440 may include delivery instructions 442, color map data 444, processing instructions 446, communication instructions 450, and/or display instructions 452.

In some examples, the computer-readable medium 440 may store color map data 444. The color map data 444 may be an example of the color map(s) described in relation to FIG. 1, FIG. 2, and/or FIG. 3. For instance, the color map data 444 may indicate color maps (e.g., RGB gains, RGB gain curve(s), etc.) corresponding to buffers of the first display device and/or image regions corresponding to the buffers.

In some examples, the communication instructions 450 are instructions, when executed, cause color maps corresponding to buffers of a first display device to be sent to a second display device. For instance, the communication instructions 450, when executed, may cause a processor (e.g., scaler) to send color maps corresponding to the buffers to a second display device. For instance, color map data 444 representing color maps may be sent to a second display device via an interface. In some examples, color maps may be sent to the second display device as described in relation to FIG. 1, FIG. 2, and/or FIG. 3. In some examples, the communication instructions 450 may be executed to receive color maps corresponding to buffers of the second display device to be received (e.g., received by the first display device).

In some examples, the delivery instructions 442 are instructions, when executed, cause a processor (e.g., a scaler circuit of a display device) to determine delivery of video data. For instance, the processor (e.g., scaler circuit) may determine a division of the video data from a source device into buffers corresponding to regions of the video data. In some examples, determining delivery of video data may be performed as described in relation to FIG. 1, FIG. 2, and/or FIG. 3.

In some examples, the communication instructions 450 are instructions, when executed, cause a processor (e.g., scaler) to receive an indicator from the second display device. For instance, the indicator may indicate an instruction to change color processing corresponding to a buffer or buffers. In some examples, the indicator may be received as described in relation to FIG. 1, FIG. 2, and/or FIG. 3. In some examples, the indicator may indicate a color map(s) of the second display device.

In some examples, the processing instructions 446 are instructions, when executed, cause a processor (e.g., scaler) to control (e.g., adjust) a color process operation corresponding to a first region of video data based on the indicator, the first region to relatively neighbor the second display device. In some examples, the processor may swap color maps between buffers and/or may adjust color processing for a buffer or buffers in accordance with the indicator. For instance, the processor may swap a color map from a second buffer to the first buffer based on the indicator. In some examples, the processor may adjust an RGB gain of the first region based on the indicator. In some examples, the adjusting color processing may be performed as described in relation to FIG. 1, FIG. 2, and/or FIG. 3.

In some examples, the display instructions 452 are instructions, when executed, cause a processor (e.g., scaler) to cause the first region to display with the adjusted color process. For instance, the processor may control the buffers to provide the first region (and/or other region(s)) to a panel for display. In some examples, the displaying the first region with the adjusted color process may be performed as described in relation to FIG. 1, FIG. 2, and/or FIG. 3.

In some examples of the techniques described herein, an indicator from a first display device and a second display device may be obtained. For instance, a first display device and a second display device may exchange indicators (e.g., color maps) and/or another device (e.g., GPU, cloud server, etc.) may receive indicators (e.g., color maps) from a first display device and a second display device. In some examples, it may be determined how video data will be delivered. For instance, the first display device, the second display device, and/or another device may determine how video data will be displayed (e.g., which video data, such as frames and/or regions, will be displayed by which display device, how the video data will be divided, etc.). In some examples, the first display device, the second display device, and/or another device may determine color map assignment (e.g., swapping and/or mapping color maps to regions, etc.) based on the delivery determination. For instance, the delivery determination may indicate which frame and/or image will be displayed of the first display device and the second display device (e.g., where each region will be located, and which regions neighbor each other at the display boundaries). The color map assignment may be determined to match and/or reduce a color difference between neighboring regions. For instance, color maps may be assigned to regions to reduce color nonuniformity across the display device(s). In some examples, a first set of color maps may be assigned to the first display device and a second set of color maps may be assigned to the second display device. A first processing pipeline of the first display device may apply the first set of color maps according to the color map assignment and/or a second processing pipeline of the second display device may apply the second set of color maps according to the color map assignment.

Some of the techniques described herein may provide reduced color discontinuities between neighboring display devices (e.g., display devices in a daisy chain arrangement). For instance, color maps may be swapped between buffers and/or corresponding regions to reduce color discontinuities between monitors. Reducing color discontinuity may enhance color continuity between display devices. Some of the techniques described herein may be performed automatically using a scaler circuit and/or based on received user input.

A technique or techniques, a method or methods (e.g., method 100) and/or an operation or operations described herein may be performed by (and/or on) a sink device and/or a device that is a sink device and a source device. For instance, a technique or techniques described herein may be performed on a display device, monitor, television, computer with an integrated display panel, etc. In some examples, a source device and/or a sink device may include circuitry (e.g., a processor with instructions and/or connection interface circuitry) to perform a technique or techniques described herein.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, aspects or elements of the examples described herein may be omitted or combined.

1. A method, comprising:
dividing, by a first display device, video data into multiple buffers corresponding to regions of the video data;
receiving, by the first display device, an indicator from a second display device; and
controlling, by the first display device, color processing of data of a first buffer of the multiple buffers based on the indicator to coordinate with the second display device.

2. The method of claim 1, wherein the first display device comprises a scaler circuit to divide the video data into the multiple buffers.

3. The method of claim 1, wherein controlling color processing comprises controlling a red, green, and blue (RGB) gain of the first buffer independently from a second buffer of the multiple buffers.

4. The method of claim 1, further comprising applying a red, green, and blue (RGB) gain curve over the multiple buffers corresponding to the regions.

5. The method of claim 1, wherein controlling the color processing of the data of the first buffer comprises swapping a first color map of the first buffer with a second color map of a second buffer.

6. The method of claim 1, wherein controlling the color processing of the data of the first buffer comprises adjusting a first color map of the first buffer to coordinate with the second display device by reducing a color difference at an edge of a display panel of the first display device that borders the second display device.

7. The method of claim 1, wherein the regions correspond to spatial subsets of a display panel.

8. The method of claim 1, wherein the indicator is a color map of the second display device.

9. The method of claim 1, further comprising sending a color map to the second display device, wherein the indicator from the second display device is received in response to sending the color map and indicates a change in the color processing of the data of the first buffer.

10. A first display device, comprising:
a scaler circuit to receive an indicator to coordinate display color with a second display device, to receive video data from a source device, to split the video data into video data subsets, and to control color processing of a first video data subset based on the indicator;
a plurality of buffers coupled to the scaler circuit, the plurality of buffers to respectively store the video data subsets; and
a panel to display the video data subsets.

11. The first display device of claim 10, wherein the scaler circuit is to
produce an on-screen display (OSD); and
receive the indicator in response to the OSD.

12. The first display device of claim 11, wherein the scaler circuit is to swap color maps between the first video data subset and a second video data subset in response to the indicator.

13. A non-transitory tangible computer-readable medium comprising instructions when executed cause a processor to:
cause color maps corresponding to buffers of a first display device to be sent to a second display device;
receive an indicator from the second display device;
control a color process operation corresponding to a first region of video data based on the indicator, the first region to relatively neighbor the second display device; and
cause the first region to display with the adjusted color process.

14. The non-transitory tangible computer-readable medium of claim 13, wherein the processor is to swap a color map from a second buffer to the first buffer based on the indicator.

15. The non-transitory tangible computer-readable medium of claim 13, wherein the processor is to adjust a red, green, and blue (RGB) gain of the first region based on the indicator.
